(19) United States
(12) Patent Application Publication
(10) Pub. No.: US 2008/0211622 A1
(43) Pub. Date: Sep. 4, 2008

(54) Deliberate Access Permission To Data On Contactless Devices

(76) Inventors: Klaus Rindtorff, Weil im Schoenbuch (DE); Albert Schaal, Tuebingen (DE)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 12/023,462

(22) Filed: Jan. 31, 2008

(30) Foreign Application Priority Data
Jan. 31, 2007 (DE) 07101461.7

(51) Int. Cl. G06F 7/04

(52) U.S. Cl. 340/5.2

(57) ABSTRACT

A method for allowing access to data or logic implemented on a device (15) is disclosed. The device may be a contactless communication chip device, such as RFID (Radio Frequency Identification) device, for example in form of a Smart Card. The proposed method enables for more user comfort than earlier methods granting access to a contactless device. An acceleration sensor (26) integrated with a logic circuit of the device (15) generates a signal. The device tests (54, 58; 64, 68), if a signal pattern generated by the acceleration sensor (26) complies with a predetermined reference pattern stored on the device (15). Access (59, 69) to the information on the device (15) is allowed for a reader device, if the signal pattern complies with the reference pattern.

### 1. BACKGROUND OF THE INVENTION

1.1. Field of the Invention

The present invention relates to the field of Electronic Computing and in particular to a method and respective system for allowing access to data or logic implemented on a device, such as a contactless communication chip device and, in particular, an RFID (Radio Frequency Identification) device, for example in form of a SmartCard.

1.2. Description and Disadvantages of Prior Art

The use of smart cards with contactless interfaces and certainly the use of RFID devices become more and more attractive to all kind of applications. The most prominent of these applications are certainly the new passports and visas incorporating a contactless chip containing biometric and other personal data. Other, less publicly discussed, applications like credit cards, public transport tickets and company ID cards are increasingly equipped with contactless smart card or RFID chips. An advantage of the contactless communication capabilities of these devices is that they need only to be placed close to an interface devices usually called a reader, in order to communicate with them.

FIG. 1 shows the essential structural elements of a prior art RFID device 10 generating a RF transmission field 8. The RFID device 10 comprises a transmission unit and an antenna (not depicted) for generating an RF transmission field 8 as it is known from prior art. A RFID chip device 15 comprises a transmission unit 16 and an antenna 18 in order to send and receive modulated signals transmitted via the RF transmission field of the reader device 10. The RFID chip device 15 contains a central processing unit (CPU) 23 and a memory 13. Business logic 22 and data 19 are stored in the memory 13.

In this exemplary prior art circuit, a basic access control (BAC) unit 20 is implemented on the RFID chip device 15. The BAC unit 20 enables access to the data stored on the RFID chip only, if the user successfully runs the access control dialogue and machine readable optical data is used to establish a secured channel between the chip 15 and the reading device 10 is implemented on the RFID chip 15. The access control dialogue may contain, for example, sensing the user's fingerprints, or verifying a predefined password or sensing different biometric characteristics of the RFID chip device holder (user). Once the dialogue has successfully finished, a business logic 22 may start running. During the business logic execution, personal data 19 associated with the RFID chip holder person is transmitted according to prior art from the chip device 15 to the reader device 10.

In FIG. 1B a similar device as shown in FIG. 1A is shown, except that the device in FIG. 1B is implemented without such a BAC unit 20. In this case a dialogue 21 between a logic implemented in the reader device 10 and the business logic 22 may be started, initiated and triggered by the reader device 10 without any admission and without any authentication dialogue run at the RFID chip device side.

The above-mentioned advantage is on the other side a disadvantage, because the communication can take place without being noticed by the owner of the device (e.g. the holder of a passport) and data can be read or in some cases data can even be modified without the owner's consent. For a passports issued with a contactless chip containing personal data, the problem of unauthorized reading of personal data has been addressed by the Basic Access Control (BAC) using machine readable optical data to establish a secured channel between the chip in the passport and the reading device. This is a rather expensive approach which is justifiable only for high security applications requiring that the passport or the card is handed to person. For applications of contactless cards in public transport applications where low transaction times and complete automation is required, the above describe method based on optical secure channel is not suitable.

Other methods trying to solve the problem of unauthorized communications with a contactless device have been described in German patent application DE 100 00 995 by Horst Henn et al., which describes several methods and/or devices to authorize a contactless smart card to communicate with a reading or recording device. All the described methods mentioned there require that the card is touched by the card holder within a certain area or in certain manner.

The disadvantage of all methods proposed in DE 100 00 995 is that they imply a certain construction of the document, the card, or (generally) the item containing the contactless chip and the access control means. They all need a certain control area to be pressed or touched. This special construction with a defined control area has several disadvantages: First, the item containing the contactless chip has to be held in a certain way in order to activate the release function. By this, one of the major advantages of contactless devices has been lost, because a spontaneous actuation is not possible anymore. Second, the item and the release mechanism cannot be operated without taking it out of a wallet or a bag. So, particularly in cold times when people wear gloves, the handling is complicated. Third, Smart card chips or RFID tags cannot be placed into very small devices or incorporated invisibly into objects like cloths, as the control area takes too much space.

All before-described mechanisms are somehow geared to the form factor of a credit card. For items with other form factors like passports, or cloth-inherent RFID-tags the proposed mechanisms result in difficult handling or, they are not feasible at all.

### 1.3. OBJECTIVES OF THE INVENTION

The objective of the present invention is to provide a method and respective system for deliberately allowing access to data or logic implemented on a communication device. The method and respective system aim to provide user comfort in connection with deliberately providing access to information on the communication device.

### 2. SUMMARY AND ADVANTAGES OF THE INVENTION

This objective of the invention is achieved by the features stated in enclosed independent claims. Further advantageous arrangements and embodiments of the invention are set forth in the respective subclaims. Reference should now be made to the appended claims.

According to a first aspect of the invention, a method is provided for allowing access to information on a device, the method comprising the steps of:

generating a signal by an acceleration sensor integrated with a logic circuit of said device,

testing within said device, if a signal pattern generated by said acceleration sensor complies with a predetermined reference pattern stored on said device, and

allowing access to said information on said device for a reader device, if said signal pattern complies with said reference pattern.

The information to which access is granted may be data stored on the device or logic implemented on the device. When allowing access to the information on the device, the signal pattern is typically checked to comply with the reference pattern with a predetermined degree of certainty. The device may be called a contactless device, since there is no need to bring the device into physical contact with the reader device. The device typically has a communication unit, for allowing the device to communicate over a wireless interface with a reader device.

A second aspect of the invention provides a device comprising a logic circuit operable on information stored at said device, said device characterised by

an activation circuit for activating said logic circuit to listen to a polling signal generated by a reader device, and

an acceleration sensor integrated with said logic circuit and coupled to said activation circuit for feeding said activation logic with a sensor signal.

A third aspect of the invention provides a data processing program product comprising a computer-usable medium and a computer readable program, wherein the computer readable program when executed on a data processing system causes the data processing system to:
receive a signal by an acceleration sensor,
test, if a signal pattern generated by said acceleration sensor complies with a predetermined reference pattern, and
allow access to information for a reader device, if said signal pattern complies with said reference pattern.

A fourth aspect of the invention provides a microchip device having programmed circuit means for performing the steps of:

receiving a signal by an acceleration sensor,

testing, if a signal pattern generated by said acceleration sensor complies with a predetermined reference pattern, and

allowing access to information for a reader device, if said signal pattern complies with said reference pattern.

In other words, in order to overcome the above described problems and disadvantages, the basic idea of the present invention comprises to integrate an acceleration sensor into the contactless device and to include a logic for coupling the data access permission to the requirement of sensing a pre-defined motion or acceleration or orientation condition.

By that the contactless device is enabled to distinguish between authorized and non-authorized communication attempts by sensing the acceleration while powered by the radio frequency (RF) transmission field of a reading device. Only if the measured acceleration is in a range corresponding to a deliberate movement of the device, the communication attempt will be honoured and access to protected information will be granted.

In a public transport application for example, the owner of a contactless ticket will just wag, i.e. waggle his ticket above to the reading device in order to authorize communications with the reader. This movement can be performed without taking the ticket out of the wallet or bag, and in can be performed wearing gloves. Thus, a larger article comprising the RFID chip, e.g., the wallet comprising the RFID chip can be wagged, in order to produce the intended sensor signals for allowing data access. The authorization process is very fast and does not influence noticeably the transaction time and throughput of the system.

Similarly, the near field communication of a mobile telephone (cell phone) may be controlled in the specified manner. A smart card in accordance with the present invention may be present in a mobile telephone. The user of the mobile phone may authorise access to certain information on the smart card, for example to information relating to making payments, by moving the mobile phone in the specified manner. The functionality according to the present invention may alternatively be incorporated directly in a mobile telephone or a cell phone instead of incorporation in a smart card that is insertable into a mobile telephone.

When RFIDs are used to tag goods (e.g. clothes) the advantage of the authorization by means of acceleration sensing is that the tag can be read by the cashier but not by an unauthorized person just collecting data about the buying habits.

Even in a category of future applications like intelligent household appliances, such as washing machines and the like, the RFID tag with the acceleration sensor works well and can release the data required for safe intelligent operation.

A further, particular implementation is an implementation wherein the acceleration sensor is an orientation sensor. An orientation sensor is a specific form of an acceleration sensor measuring the orientation of the device. It can distinguish between vertical and horizontal orientation of the contactless device allowing e.g. reading of a card or a travel document by a machine.

Current implementations of chips for passports bear a problem which has not been solved by the above described BAC mechanism. When the chip is within a RF transmission field, like when it's close to a reader, the chip will respond with a chip-unique identification when it is asked by the reader to do so. A prior art contactless chip cannot distinguish between a legitimate reader and a bogus reader and this property of the contactless protocols can be misused to construct so-called movement-profiles of persons without them noticing it. Coupling the release of chip-unique data to a signal of the acceleration detection, can prevent such attacks.

### 3. BRIEF DESCRIPTION OF THE DRAWINGS

The present invention is illustrated by way of example and is not limited by the shape of the figures of the drawings in which:

FIG. 1 illustrates the essential structural elements of a RFID device and an associated reader device generating a RF transmission field;

FIG. 2 illustrates a device according to a preferred embodiment of the present invention, in the same view as in FIGS. 1A, and 1B;

FIG. 3 illustrates how to activate an acceleration sensor according to a preferred embodiment of the present invention;

FIG. 4 illustrates how to activate an orientation sensor implemented in an RFID chip according to a further embodiment of the present invention;

FIG. 5 illustrates the control flow in the process of detecting the acceleration within a contact less chip device according to the present invention, according to the embodiment shown in FIG. 3;

FIG. 6 illustrates the control flow similar to FIG. 5 associated with the orientation sensor implemented in the RFID chip device shown in FIG. 4.

### 4. DETAILED DESCRIPTION OF THE PREFERRED EMBODIMENT

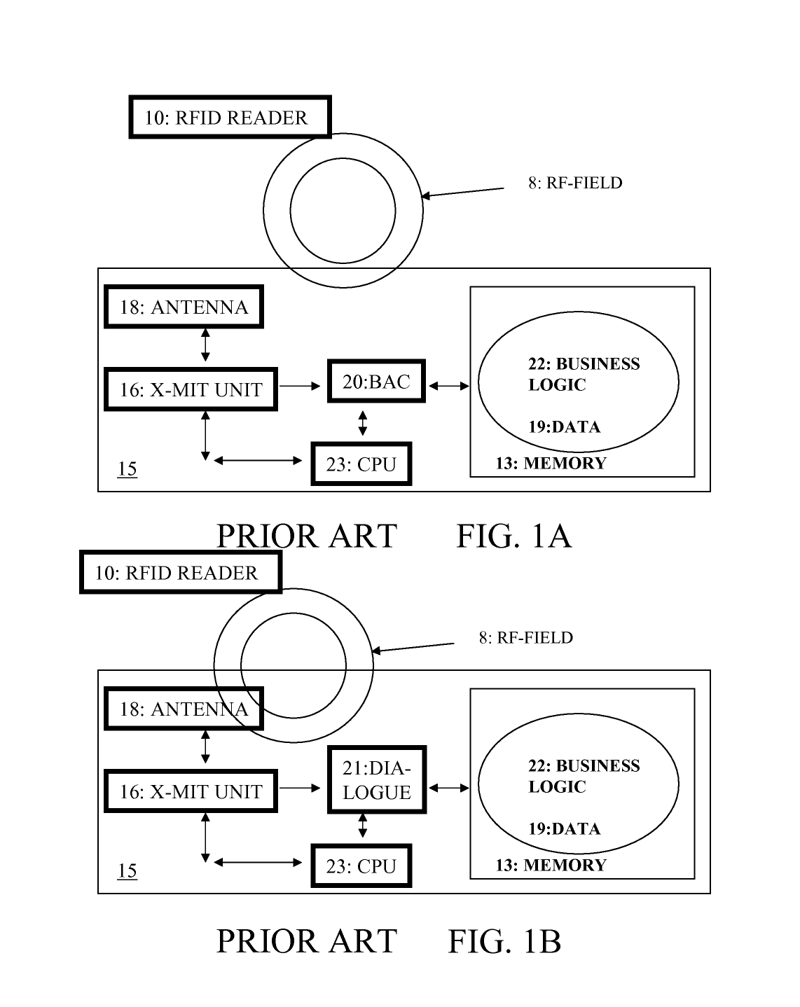

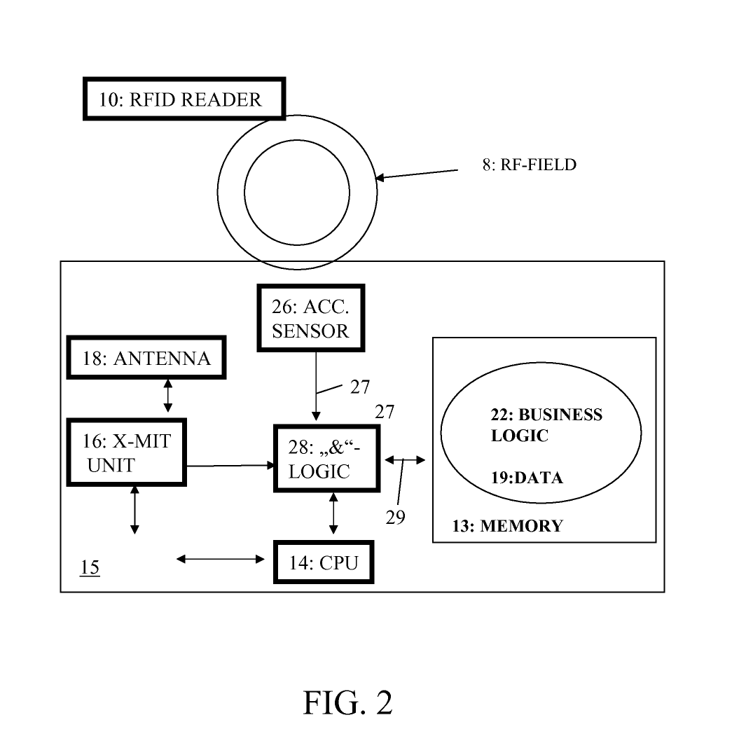

FIG. 2 shows the basic principle disclosed by a preferred embodiment of the present invention by aid of a schematic circuit diagram. Basically, and in contrast to FIG. 1A, an acceleration sensor device 26 is implemented at the RFID chip within the RFID device 15. The acceleration sensor 26 generates a signal along its output signal line 27, which is fed into a comparator circuit 28. The other input of the comparator circuit 28 is the signal received from the transmission unit 16 of the RFID chip device.

The comparator circuit 28 processes both signals and generates an output signal on signal line 29 which activates the business logic 22 only if the acceleration sensor output signal 27 makes the logic of comparator circuit 28 decide that the RFID chip has been accelerated by a respective movement of the RFID chip according to a pre-programmed acceleration pattern.

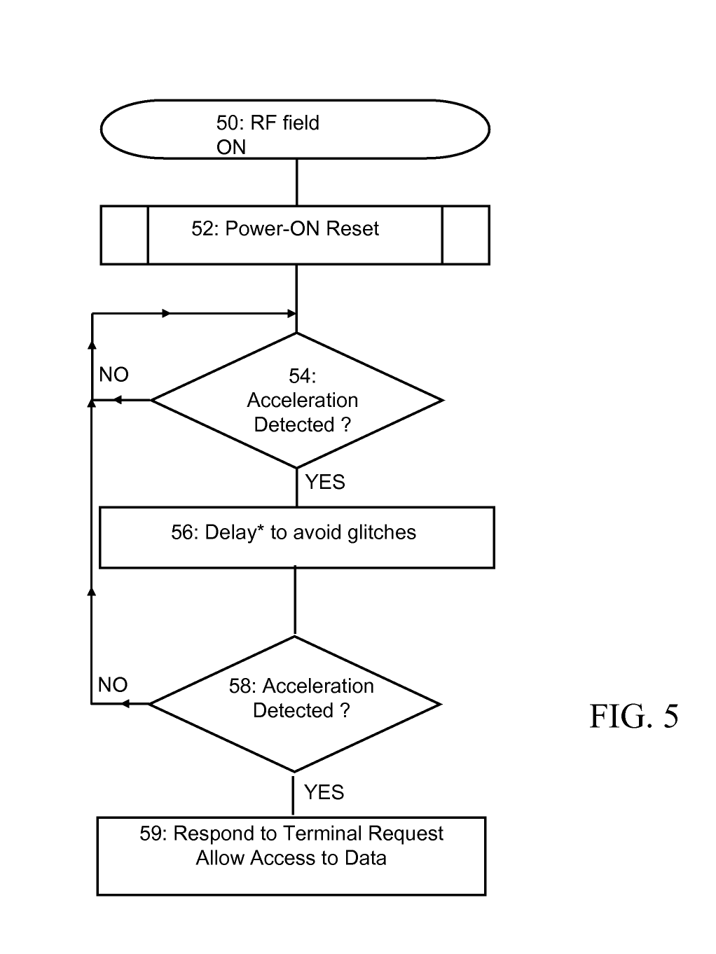

This pattern is preferably hard-wired coded within the comparator circuit 28, in order to prevent this verification logic from being faked by respective signals transmitted via a “fraud” reader device. Details of the control flow are given in FIG. 5. Thus, basically, comparator circuit 28 opens if both conditions apply, first a read (poll) signal coming in intending to begin communication with the inventional RFID chip, and second, the acceleration is successfully sensed. Thus, a kind of AND- (&) circuit 28 or appropriate implementation in the card operating software is implemented.

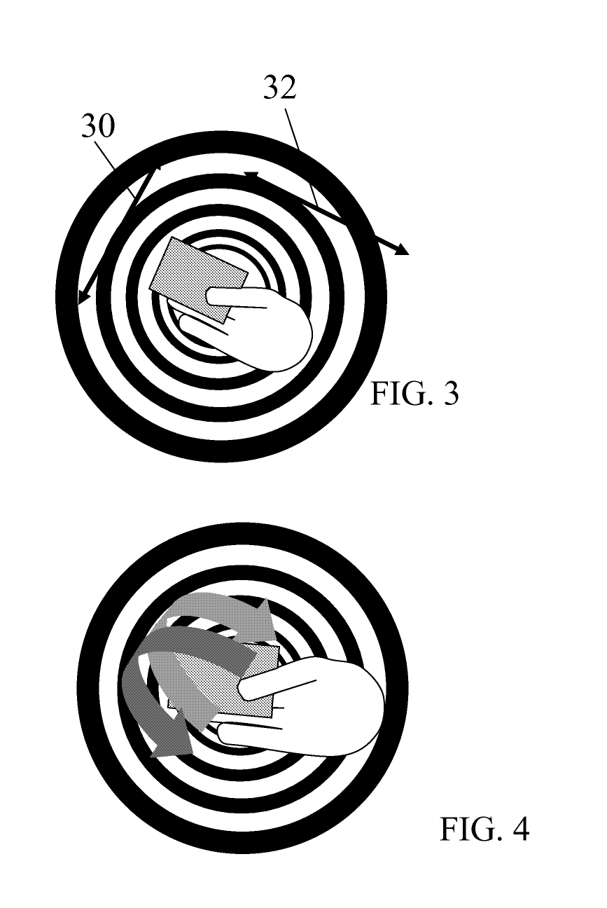

In FIG. 3 arrows 30, 32 show the prescribed movement of a card comprising a RFID chip, for example a passport and a surrounding RFID transmission field issued by a respective reader device (not depicted). The RFID chip's acceleration sensor produces output signals of a sufficient amplitude only if the card is moved in the direction of one of the arrows 30, 32. Of course, a bidirectional motion can be performed by the card holder in order to get the sensor produce sufficient amplitude signals. If the card is moved perpendicular to this direction and perpendicular to the paper level no relevant signals are generated by the sensor because the sensor is limited to sense only accelerations in arrow direction. This is preferred because prior art semiconductor circuits are basically implemented in a thin plane and the sensors need some physical size to extend in, in order to function properly. Thus, it is difficult to integrate an acceleration sensor sensing complete 3D motion as the Z-sensitive sensor element would extend beyond the circuit level. Thus, the schema depicted in FIG. 3 is disclosed to provide relatively simple and cheap sensor integration with the RFID chip circuit.

Of course, this sample implementation can be enriched by a second acceleration sensor which senses accelerations in direction of either of the arrows 30, 32, in order to enable an access to the business logic 22 also in cases in which the card holder keeps the card in the orientation depicted with rectangle 34. The skilled reader will appreciate, that the sensor output signals can be ORed by the comparator logic 28 in order to enable access to the business logic 22. This functionality of the comparator logic 28 can be provided also by an appropriate implementation in the card operating software.

FIG. 4 shows a further embodiment of the present invention which implements an orientation sensor. This sensor may distinguish an orientation of the sensor and thus an orientation of the card which is horizontal or vertical. Thus, an admission control algorithm may for example be implemented which expects the card to be turned from horizontal to vertical orientation and back to horizontal orientation within a prescribed time interval of for example 2 seconds.

FIG. 5 illustrates the control flow implemented in comparator circuit 28 for the acceleration sensor given in FIG. 3.

As stage 50 which is a part of the transmission unit 16 indicates, the radio frequency field (RF field) is assumed to be ON. The RF reader device 10 thus steadily transmits RF waves for polling to get answered by a respective back-transmission. The back-transmission is interpreted as a response from a RFID chip device, as is known from prior art.

As stage 52 indicates, the RFID chip device 25 according to the present invention may be assumed to be set in a standby-mode in which the comparator circuit 28 is activated and listens to the output signal of acceleration sensor 26 exclusively. As long as no acceleration signal is detected, see decision 54, the poll signal received by transmission unit 16 and issued by the reader device 10 will not be evaluated at all. Thus, the reader device polls in vain. In this case the loop 54 is waiting for a detection of an acceleration signal. Once this acceleration signal is detected, these signals will be sampled and temporarily stored within the comparator circuit 28.

The acceleration signal is sampled during some predetermined time interval in order to make sure that the acceleration signal has been generated by a deliberate movement of the card holder. The device may average measurements taken during this interval and/or or calculate a moving average value to ensure that a valid acceleration signal is present. If a delay is used, the respective delay may be adjusted in the range of some milliseconds. The actual value depends on the application and usage of the contactless device. Thus, a second decision 58 is taken in which the acceleration sensor output signal is observed during a time which can be assume to be long enough to exclude undeliberate movement by the card holder.

So, in the NO-case of decision 58, control is fed back to step 54. The signal is still observed and a respective data stream is respectively analysed during a time window of the length of the before-mentioned delay time. If the signal is long enough on an amplitude level higher than basically noise level this signal is evaluated, if it fulfils the predetermined and hard-wired programmed reference pattern dedicated to get access to the business logic 22. Thus, if the signal evaluation logic comprised of comparator circuit 28 ends up with a positive check saying that the measured acceleration signal complies to the demanded signal pattern, then in step 59 the access to the data stored on the RFID chip device is allowed and the business logic 22 may respond in step 59 to the terminal request issued by the reader device 10.

A simple and probably good example for a acceleration pattern will be an acceleration peak of a certain amplitude, a single peak which can be generated by the card holder just by impinging the card on a hard surface, like a table, a finger, etc. Of course, other more complicated patterns may also be implemented.

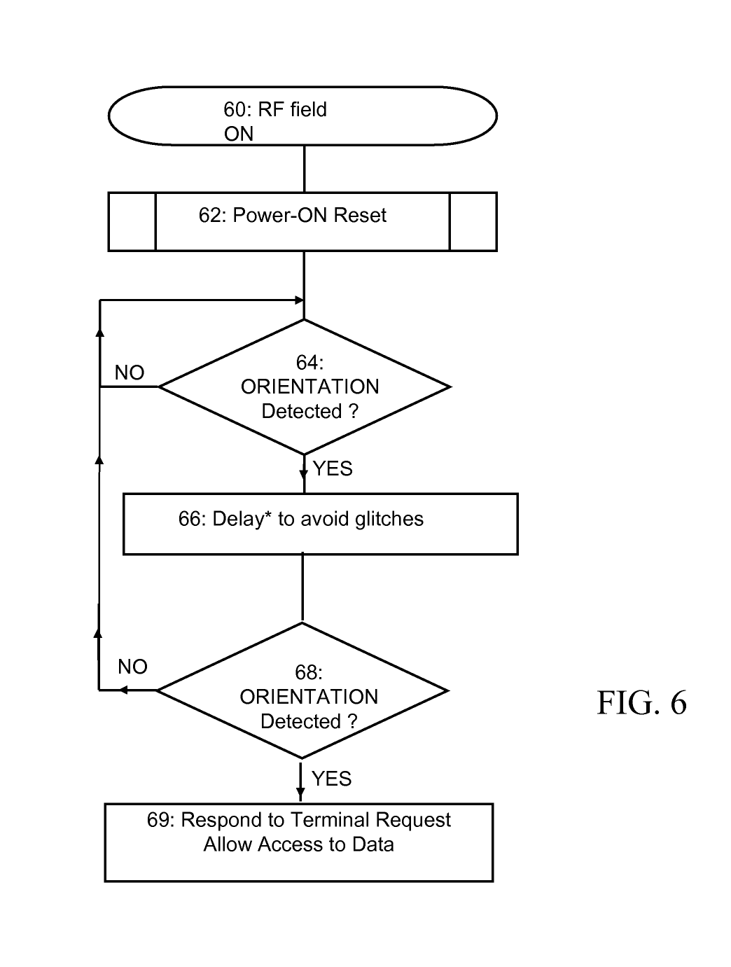

FIG. 6 shows a respective control flow of the evaluation logic implemented in comparator circuit 28 in a RFID chip device which may be activated by an orientation sensor as depicted in FIG. 4. Here, basically the same steps are followed as in FIG. 5. Steps 60 and 62 correspond to step 50 and 52. Instead of an acceleration detection in step 54, here an orientation test is performed in step 64, for testing if the sensor is held, for example, in a vertical position. Then further instead of a second acceleration test 58 here, an orientation test 68 will be performed testing, if the sensor is held, for example, in a horizontal position. Of course, both tests 64 and 68 must be within a predetermined time range of, for example 2 seconds. Finally, in a step 69 access to the data will be allowed and a respective response to the terminal request from the reader device 10 will be generated. Also here, a skilled reader may appreciate that various modifications of the required orientation patterns can be implemented.

For example, a prescribed pattern can be required to be repeated multiple times, or some peaks may be required to occur between prescribed patterns and within any prescribed time window, etc.

It is appreciated that a device in accordance with the invention may form part of a larger article. An article here refers to any article of manufacture, which is able to carry a communication chip 15 in an incorporated way or fixed to it anyhow differently, e.g., by an adhesive medium in a sealed or unsealed way. Prominent articles are tickets, goods ready to be sold from a shop, documents, visa, etc.

The present invention can be realized in hardware, software, or a combination of hardware and software. A tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following: a) conversion to another language, code or notation; and b) reproduction in a different material form.

The computer program or program product is typically provided on a computer-readable medium. The computer-readable medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The foregoing detailed description of embodiments of the invention is provided for the purposes of illustration and is not intended to be exhaustive or to limit the invention to the embodiments disclosed. The scope of the present invention is defined by the appended claims.

1. A method for allowing access to information on a device, comprising:
generating a signal by an acceleration sensor coupled to a logic circuit of said device;
testing within said device, whether a signal pattern of the signal generated by said acceleration sensor complies with a predetermined reference pattern stored on said device; and
allowing access to said information on said device to a reader device, in response to said signal pattern complying with said predetermined reference pattern.

2. The method according to claim 1, further comprising checking at least one of the following:
an acceleration output of said acceleration sensor; or
a change in orientation of said acceleration sensor.

3. The method according to claim 1, further comprising sensing acceleration for a direction component lying with a layout plane of a chip incorporating said logic circuit.

4. The method according to any preceding claim 1, further comprising sampling said signal during a predetermined time period for ensuring that said signal has been generated by deliberately moving said device.

5. A device, comprising a logic circuit operable on information stored at said device, said device comprising:
an activation circuit for activating said logic circuit to listen to a polling signal generated by a reader device; and
an acceleration sensor integrated with said logic circuit and coupled to said activation circuit for feeding said activation logic with a sensor signal.

6. A device according to claim 5, wherein said acceleration sensor comprises an orientation sensor.

7. The device according to claim 5, further comprising a predetermined reference pattern hard-coded within said device for checking that said sensor signal complies with said predetermined reference pattern.

8. The device according to claim 5, wherein said logic circuit and acceleration sensor are integrated with at least one of the following:
a radio-frequency-identifier chip, an or
a smart card.

9. The device according to claim 5, said information comprising information relating to at least one of the following:
a passport,
a visa document,
an identification document,
a travel ticket,
a device identification, or
payment information.

10. A data processing program product comprising a computer-usable medium and a computer readable program, wherein the computer readable program when executed on a data processing system causes the data processing system to:
receive a signal by an acceleration sensor;
test whether a signal pattern of the signal generated by said acceleration sensor complies with a predetermined reference pattern; and
allow access to information to a reader device, in response to said signal pattern complying with said reference pattern.

11. A microchip device comprising:
circuitry that receives a signal by an acceleration sensor,
circuitry that tests whether a signal pattern of the signal generated by said acceleration sensor complies with a predetermined reference pattern and
circuitry that allows access to information by a reader device, in response to said signal pattern complying with said reference pattern.

12. A microchip device according to claim 11, arranged to be insertable into a mobile telephone and to control access to information relating to making payments.

13. The method of claim 1, further comprising:
receiving a poll signal from the reader device, wherein access to the information on the device is provided to the reader device only in response to both the signal pattern complying with the reference pattern and the poll signal being received from the reader device.

14. The method of claim 13, wherein in response to the acceleration sensor not generating a signal, the poll signal is not processed by the device.

15. The method of claim 1, wherein the acceleration sensor senses a movement of the device in only a predefined direction, and wherein movement of the device in a direction other than the predefined direction results in the signal from the acceleration sensor not complying with the predetermined reference pattern.

16. The method of claim 1, further comprising:
generating a second signal by a second acceleration sensor coupled to the logic circuit of the device;
testing, within said device, whether a second signal pattern of the second signal generated by the second acceleration sensor complies with a second predetermined reference pattern stored on the device; and
allowing access to the information on the device to a reader device, in response to at least one of the signal pattern complying with the predetermined reference pattern or the second signal pattern complying with the second predetermined reference pattern.

17. The method of claim 4, further comprising:
generating at least one of an average of the samples of the signal or a moving average of the samples of the signal during the predetermined time period; and
using the average or the moving average as the signal pattern of the signal.

18. The method of claim 1, wherein the predetermined reference pattern identifies a repeated prescribed pattern requiring a repeated motion of the device to generate a repeated signal pattern of the signal.

19. The method of claim 1, wherein the device is an electronic card.

20. The device of claim 5, wherein the activation logic further comprises testing logic that determines whether a signal pattern of the sensor signal complies with a predetermined reference pattern, and wherein the activation logic activates the logic circuit only in response to the signal pattern of the sensor signal complying with the predetermined reference pattern within a predetermined tolerance.
